(19) United States
(12) Patent Application Publication
(10) Pub. No.: US 2017/0245314 A1
(43) Pub. Date: Aug. 24, 2017

(54) COMMUNICATION DEVICE, COMMUNICATION METHOD, AND COMPUTER PROGRAM PRODUCT

(71) Applicants: Kohki OHHIRA, Tokyo (JP); Masaru KURODA, Tokyo (JP); Shintaro KAWAMURA, Kanagawa (JP); Hiroki SUGINO, Kanagawa (JP)

(72) Inventors: Kohki OHHIRA, Tokyo (JP); Masaru KURODA, Tokyo (JP); Shintaro KAWAMURA, Kanagawa (JP); Hiroki SUGINO, Kanagawa (JP)

(73) Assignee: RICOH COMPANY, LTD., Tokyo (JP)

(21) Appl. No.: 15/515,014

(22) PCT Filed: Oct. 9, 2015
(86) PCT No.: PCT/JP2015/005154

§ 371 Date: Mar. 28, 2017

(30) Foreign Application Priority Data
Oct. 10, 2014 (JP) 2014-209464
Aug. 25, 2015 (JP) 2015-166172

(51) Int. Cl. H04W 76/02; H04B 17/318; H04W 76/06; H04L 9/08; H04W 12/08; H04W 8/00; H04B 10/114; H04B 11/00; H04W 4/00; H04W 12/04

(52) U.S. Cl. CPC H04W 76/023; H04W 4/008; H04B 17/318; H04W 76/068; H04W 12/04; H04W 12/08; H04W 8/005; H04B 10/114; H04B 11/00; H04L 9/0822; H04W 84/12

(57) ABSTRACT

A communication device includes: a communication unit that performs communication with another communication device in a first range through a first communication scheme; and a detecting unit that detects prescribed information within a second range different from the first range. When the detecting unit detects the prescribed information, the communication unit performs communication with the other communication device within the second range through the first communication scheme.

### TECHNICAL FIELD

The present invention relates to a communication device, a communication method, a system, and a computer program product.

### BACKGROUND ART

Wireless LANs are known today that enable wireless communications by radio waves with remote computers via access points in a network. The LAN is an abbreviation for “local area network”. The wireless LAN offers enhanced convenience and is thus widespread.

Before a wireless LAN is built, communication parameters need to be set. Building a wireless LAN, however, requires a high level of knowledge of a technical communication parameter setup and thus has unfortunately been a problem involving tremendous difficulty. Against this background, setup systems, such as WPS (trademark) or AOSS (trademark), have been developed to make the setup of the wireless LAN even a bit easier. WPS is an abbreviation for “Wi-Fi Protected Setup”, and Wi-Fi is an abbreviation for “Wireless Fidelity”. AOSS is an abbreviation for “AirStation One-Touch Secure System”.

These setup systems enable the setup of a wireless LAN between devices, such as a wireless LAN router and a personal computer device, constituting the wireless LAN by, for example, with the press of a dedicated button disposed in each of the devices (pushbutton system). Alternatively, these setup systems enable the setup of the wireless LAN between a master device and a slave device with the input of a number consisting of several digits issued by the master device into the slave device (PIN code system).

Patent Literature 1 (Japanese Laid-open Patent Publication No. 2002-351766) discloses a setup file transmission system intended for facilitation of the wireless LAN setup. With this setup file transmission system, when a distance between a personal computer device of a wireless LAN provider and a user terminal is equal to or less than a predetermined distance, a server device prepared by the wireless LAN provider transmits communication parameters for setting the wireless LAN through Bluetooth (registered trademark) communication. The user terminal receives the transmitted communication parameters and performs the setup of the wireless LAN. This facilitates the wireless LAN setup.

### SUMMARY OF INVENTION

### Technical Problem

The known WPS and AOSS setup systems, however, require manual operations for the wireless LAN setup performed by the user and thus unfortunately take time and labor for making the setup. Additionally, the PIN code system may involve operation based on a PIN code that is a completely fixed value. Moreover, with the PIN code system, the same PIN code continues to exist for use even after the device has withdrawn from a communication range of the built-up wireless LAN. As a result, the device that has withdrawn from the communication range can still continue performing communication, so that the PIN code system entails a communication security problem.

For the setup file transmission system disclosed in Patent Literature 1, once the setup is completed and a communication line is established between, for example, the device and the wireless LAN router, the established communication line continues to be maintained. Additionally, for the setup file transmission system disclosed in Patent Literature 1, the same authentication information and encryption information continue to exist for use even after the device has withdrawn from a communication range of the built-up wireless LAN. This poses a communication security problem.

In view of the foregoing, there is a need to provide a communication device, a communication method, a system, and a computer program product that can be simply set up and connected with a local area network and that can be used with security.

### Solution to Problem

A communication device includes: a communication unit that performs communication with another communication device in a first range through a first communication scheme; and a detecting unit that detects prescribed information within a second range different from the first range. When the detecting unit detects the prescribed information, the communication unit performs communication with the other communication device within the second range through the first communication scheme.

### Advantageous Effects of Invention

An embodiment provides an effect that simple setup and connection with a local area network and use with security are enabled.

### BRIEF DESCRIPTION OF DRAWINGS

FIG. 1 is a system configuration diagram illustrating a basic configuration of a wireless LAN communication scheme.

FIG. 2 is a hardware configuration diagram illustrating a communication range limiting device disposed in the wireless LAN communication scheme that is a basic configuration.

FIG. 3 is a hardware configuration diagram illustrating a smartphone device disposed in the wireless LAN communication scheme that is the basic configuration.

FIG. 4 is a hardware configuration diagram illustrating a printer device disposed in the wireless LAN communication scheme that is the basic configuration.

FIG. 5 is a hardware configuration diagram illustrating a projector device disposed in the wireless LAN communication scheme that is the basic configuration.

FIG. 6 is a functional block diagram of the communication range limiting device disposed in the wireless LAN communication scheme that is the basic configuration.

FIG. 7 is a functional block diagram of the smartphone disposed in the wireless LAN communication scheme that is the basic configuration.

FIG. 8 is a functional block diagram of the printer device disposed in the wireless LAN communication scheme that is the basic configuration.

FIG. 9 is a sequence diagram illustrating that a smartphone that has moved into a BLE communication area within a wireless LAN communication area establishes a wireless LAN communication line in the wireless LAN communication scheme that is the basic configuration.

FIG. 10 is a sequence diagram illustrating that a printer device disposed in the BLE communication area within the wireless LAN communication area establishes a wireless LAN communication line in the wireless LAN communication scheme that is the basic configuration.

FIG. 11 is a flowchart illustrating that a smartphone connected to a wireless LAN remotely controls and causes a printer device to produce a printed matter in the wireless LAN communication scheme that is the basic configuration.

FIG. 12 is a sequence diagram illustrating that a wireless LAN communication line (and a BLE communication line) is disconnected when a smartphone connected in the BLE communication area to a printer device through a wireless LAN moves out of the BLE communication area in the wireless LAN communication scheme that is the basic configuration.

FIG. 13 is a system configuration diagram illustrating an exemplary case in which at least part of the BLE communication area is disposed outside the wireless LAN communication area in the wireless LAN communication scheme that is the basic configuration.

FIG. 14 is a schematic diagram for illustrating an overview of a wireless LAN communication scheme according to a first embodiment to which the present invention is applied.

FIG. 15 is a sequence diagram illustrating that a first device (and a second device) establishes a communication line in the wireless LAN communication scheme according to the first embodiment.

FIG. 16 is a sequence diagram illustrating that a communication line is disconnected when the first device (or the second device) moves to a second communication area in the wireless LAN communication scheme according to the first embodiment.

FIG. 17 is a flowchart for illustrating operations performed in a device connecting module of a communication range limiting device included in a wireless LAN communication scheme according to a second embodiment of the present invention to attempt to establish a wireless LAN using a public key.

FIG. 18 is a flowchart for illustrating operations performed in a peripheral device connecting module of the communication range limiting device included in the wireless LAN communication scheme according to the second embodiment to attempt to establish a wireless LAN using a public key.

FIG. 19 is a system configuration diagram illustrating a wireless LAN communication scheme according to a third embodiment of the present invention.

FIG. 20 is a system configuration diagram illustrating a wireless LAN communication scheme according to a fourth embodiment of the present invention.

FIG. 21 is a functional block diagram of a smartphone that constitutes a wireless LAN communication scheme according to a fifth embodiment of the present invention.

FIG. 22 is a flowchart illustrating disconnecting processing for the wireless LAN communication scheme according to the fifth embodiment of the present invention.

### DESCRIPTION OF EMBODIMENTS

The following details, with reference to the accompanying drawings, a wireless local area network (LAN) communication scheme according to embodiments to which the present invention is applied.

Basic Configuration

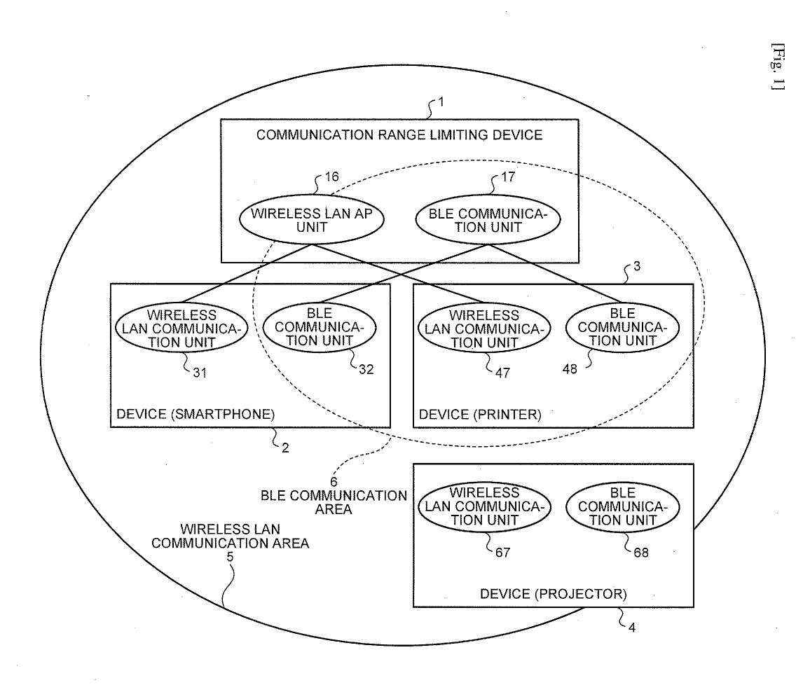

The following describes a basic configuration of the wireless LAN communication scheme according to the embodiments to be described hereunder. FIG. 1 is a system configuration diagram illustrating the basic configuration of the wireless LAN communication scheme. As illustrated in FIG. 1, the wireless LAN communication scheme includes a communication range limiting device 1, a smartphone 2 as a first device, a printer device 3 as a second device, and a projector device 4 as a third device. It is noted that each device illustrated in FIG. 1 represents only an example and may be replaced by any other device that has a communication function to be described later. For example, a tablet terminal device, a portable gaming machine, a notebook personal computer, or any other portable communication device may be used in place of the smartphone 2.

Basic Configuration of Communication Range Limiting Device

The communication range limiting device 1 forms an access point for a wireless LAN, such as a wireless LAN router. The communication range limiting device 1 forms, as an exemplary local area network, a wireless LAN communication area 5 indicated by the solid-line ellipse in FIG. 1. The communication range limiting device 1 enables communication of each device only in an area narrower than the wireless LAN communication area 5 within the wireless LAN communication area 5. For example, the communication range limiting device 1 enables communication of each device only in a personal area network (PAN) that is narrower than the wireless LAN communication area 5 within the wireless LAN communication area 5.

Exemplarily, a Bluetooth (registered trademark) PAN that performs Bluetooth (registered trademark) Low Energy (BLE) communication consuming ultra-low electric power may be used as the personal area network. In FIG. 1, a communication range indicated by the dotted-line ellipse is a BLE communication area 6 by the Bluetooth (registered trademark) PAN. The following description assumes that the personal area network is the Bluetooth PAN. Nonetheless, non-contact wireless communication (Near Field Communications (NFC)), milliwave wireless communication, QR code (registered trademark), visible light, environmental sound, and ultrasonic waves may, for example, be used instead of the Bluetooth.

Basic Hardware Configuration of Communication Range Limiting Device

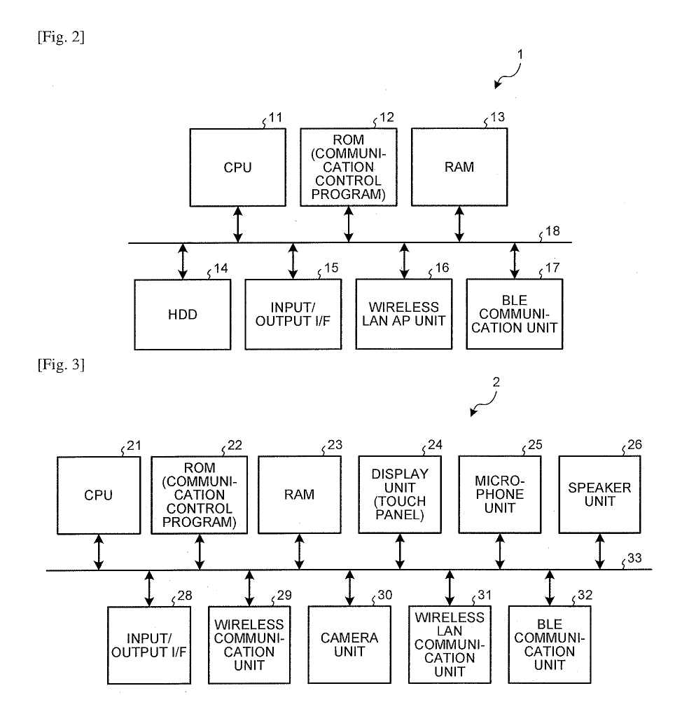

FIG. 2 illustrates a basic hardware configuration of the communication range limiting device 1. As illustrated in FIG. 2, the communication range limiting device 1 includes a central processing unit (CPU) 11, a read only memory (ROM) 12, a random access memory (RAM) 13, a hard disk drive (HDD) 14, an input/output interface (input/output I/F) 15, a wireless LAN AP unit 16 (AP stands for access point), and a BLE communication unit 17. The elements from the CPU 11 to the BLE communication unit 17 are connected to each other via a bus line 18.

The ROM 12 stores a communication control program for enabling communication of each device only in the BLE communication area 6 within the wireless LAN communication area 5. The communication control program may be stored in the RAM 13, the HDD 14, or other storage unit. The CPU 11 operates in accordance with the communication control program to thereby control the wireless LAN AP unit 16 and the BLE communication unit 17, controlling to enable communication of each device only in the BLE communication area 6 within the wireless LAN communication area 5.

In FIGS. 1 and 2, the communication range limiting device 1 is illustrated as a standalone device. The communication range limiting device 1 may, however, be incorporated in each device, for example, in a printer device or a multifunction peripheral (MFP).

Basic Hardware Configuration of Smartphone

FIG. 3 illustrates a hardware configuration of the smartphone 2. As illustrated in FIG. 3, the smartphone 2 includes a CPU 21, a ROM 22, a RAM 23, a display unit 24, a microphone unit 25, and a speaker unit 26. The smartphone 2 further includes an input/output I/F 28, a wireless communication unit 29, a camera unit 30, a wireless LAN communication unit 31, and a BLE communication unit 32. The elements from the CPU 21 to the BLE communication unit 32 are connected to each other via a bus line 33.

The ROM 22 stores a communication control program for enabling communication of each device only in the BLE communication area 6 within the wireless LAN communication area 5. The communication control program may be stored in the RAM 23 or other storage unit. The CPU 21 operates in accordance with the communication control program to thereby control the wireless LAN communication unit 31 and the BLE communication unit 32. The CPU 21 thereby enables BLE communication in the BLE communication area 6 within the wireless LAN communication area 5.

The display unit 24 integrates a touch panel formed of a transparent electrode with a display panel to thereby form what is called a touch panel-mounted display unit. The wireless communication unit 29 performs communication of, for example, telephone and e-mail via a wireless base station operating on a predetermined carrier.

Basic Hardware Configuration of Printer Device

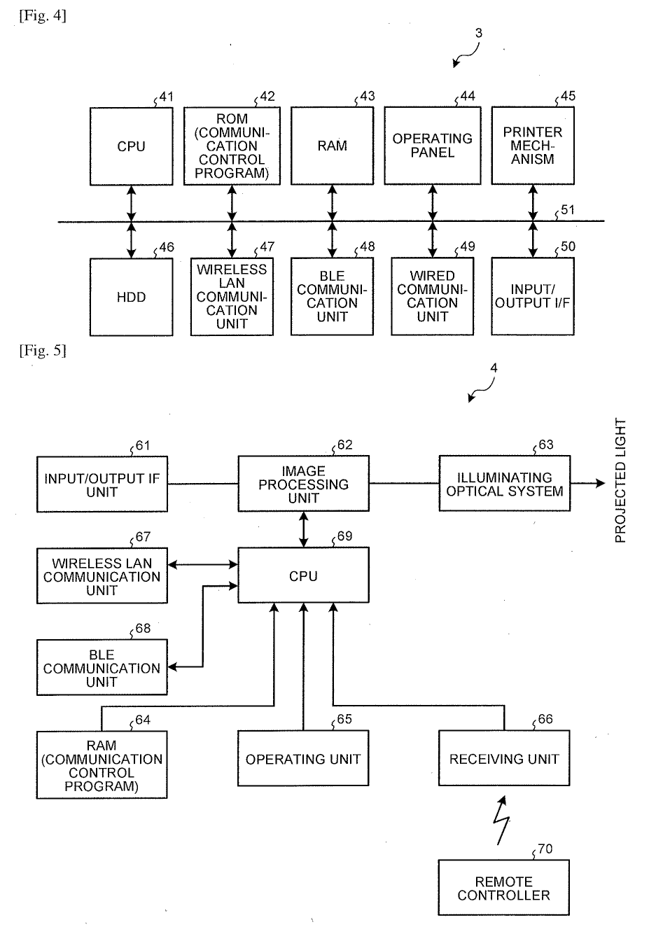

FIG. 4 illustrates a basic hardware configuration of the printer device 3. As illustrated in FIG. 4, the printer device 3 includes a CPU 41, a ROM 42, a RAM 43, an operating panel 44, and a printer mechanism 45. The printer device 3 further includes an HDD 46, a wireless LAN communication unit 47, a BLE communication unit 48, a wired communication unit 49, and an input/output I/F 50. The elements from the CPU 41 to the input/output I/F 50 are connected to each other via a bus line 51.

The ROM 42 stores a communication control program for enabling communication of each device only in the BLE communication area 6 within the wireless LAN communication area 5. The communication control program may be stored in the RAM 43, the HDD 46, or other storage unit. The CPU 41 operates in accordance with the communication control program to thereby control the wireless LAN communication unit 47 and the BLE communication unit 48. The CPU 41 thereby enables BLE communication in the BLE communication area 6 within the wireless LAN communication area 5. Additionally, the printer mechanism 45 performs printing of, for example, images and texts, in accordance with a print setup specified from the smartphone 2.

Basic Hardware Configuration of Projector Device

FIG. 5 illustrates a basic hardware configuration of the projector device 4. As illustrated in FIG. 5, the projector device 4 includes an input interface unit (input IF unit) 61, an image processing unit 62, an illuminating optical system 63, a RAM 64, and an operating unit 65. The projector device 4 further includes a receiving unit 66 that receives commands from a remote controller 70 through infrared communication, a wireless LAN communication unit 67, a BLE communication unit 68, and a CPU 69.

The projector device 4 receives image information that corresponds to a projected image supplied to the input IF unit 61 thereof. The image information is subjected to predetermined image processing including distortion correction performed by the image processing unit 62 before being projected onto, for example, a screen by the illuminating optical system 63.

The RAM 64 stores a communication control program for enabling communication of each device only in the BLE communication area 6 within the wireless LAN communication area 5. The communication control program may be stored in a ROM, a HDD, or other storage unit. The CPU 69 operates in accordance with the communication control program to thereby control the wireless LAN communication unit 67 and the BLE communication unit 68. The CPU 69 thereby enables BLE communication in the BLE communication area 6 within the wireless LAN communication area 5.

Basic Software Configuration of Communication Range Limiting Device

FIG. 6 is a block diagram illustrating functions achieved by the CPU 11 of the communication range limiting device 1 when the CPU 11 operates in accordance with the communication control program. As illustrated in FIG. 6, the CPU 11 of the communication range limiting device 1 executes the communication control program to thereby function as a device connecting module 75, a peripheral device connecting module 76, a withdrawal detecting module 77, a wireless LAN AP control module 78, and a BLE communication control module 79.

It is noted that the following description of this example assumes that the elements from the device connecting module 75 to the BLE communication control module 79 are achieved as software functions by the communication control program. The elements from the device connecting module 75 to the BLE communication control module 79 may nonetheless be achieved in part or in whole by an integrated circuit (IC) or by hardware.

The communication control program of the communication range limiting device 1 may be recorded and provided in a computer-readable recording medium such as a CD-ROM and a flexible disk (FD) as an installable or executable file. The communication control program of the communication range limiting device 1 may even be recorded and provided in a computer-readable recording medium such as a CD-R, a digital versatile disk (DVD), a Blu-ray disc (registered trademark), and a semiconductor memory. The communication control program of the communication range limiting device 1 may still be provided by being installed via a network such as the Internet. The communication control program of the communication range limiting device 1 may still be embedded and provided in a ROM of a device, for example.

Basic Software Configuration of Smartphone

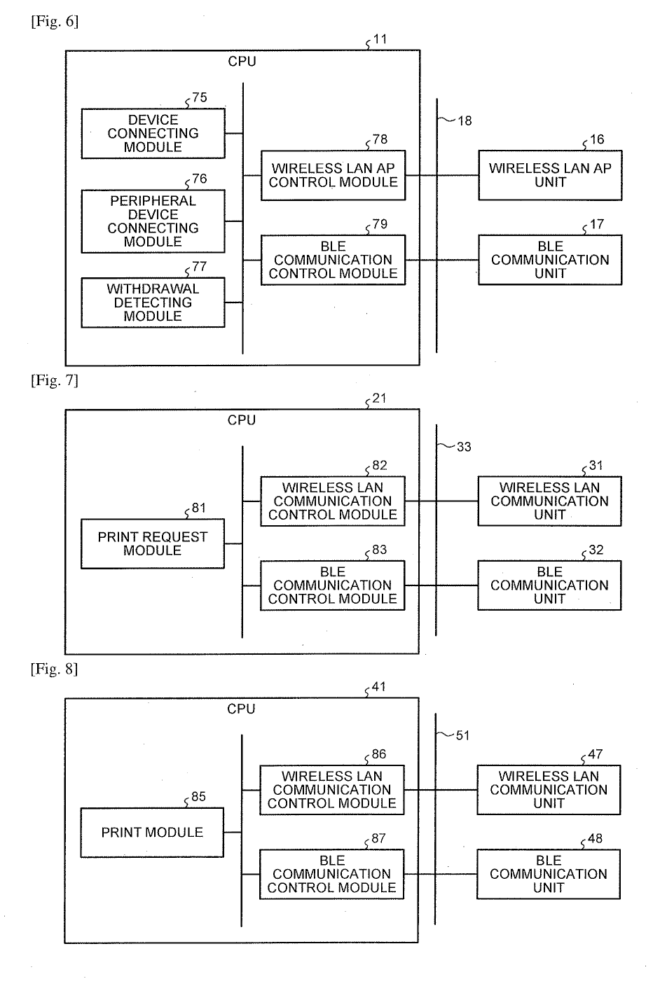

FIG. 7 is a block diagram illustrating functions achieved by the CPU 21 of the smartphone 2 when the CPU 21 operates in accordance with the communication control program. As illustrated in FIG. 7, the CPU 21 of the smartphone 2 operates in accordance with the communication control program to thereby function as a print request module 81, a wireless LAN communication control module 82, and a BLE communication control module 83. The print request module 81 achieves a function of remotely operating the printer device 3 through BLE communication to thereby cause the printer device 3 to print a desired image or text, for example.

It is noted that the following description of this example assumes that the elements from the print request module 81 to the BLE communication control module 83 are achieved as software functions by the communication control program. The elements from print request module 81 to the BLE communication control module 83 may nonetheless be achieved in part or in whole by an integrated circuit (IC) or by hardware.

The communication control program of the smartphone 2 may be recorded and provided in a computer-readable recording medium such as a CD-ROM and a flexible disk (FD) as an installable or executable file. The communication control program of the smartphone 2 may even be recorded and provided in a computer-readable recording medium such as a CD-R, a digital versatile disk (DVD), a Blu-ray disc (registered trademark), and a semiconductor memory. The communication control program of the smartphone 2 may still be provided by being installed via a network such as the Internet. The communication control program of the smartphone 2 may still be embedded and provided in a ROM of a device, for example.

Basic Software Configuration of Printer Device

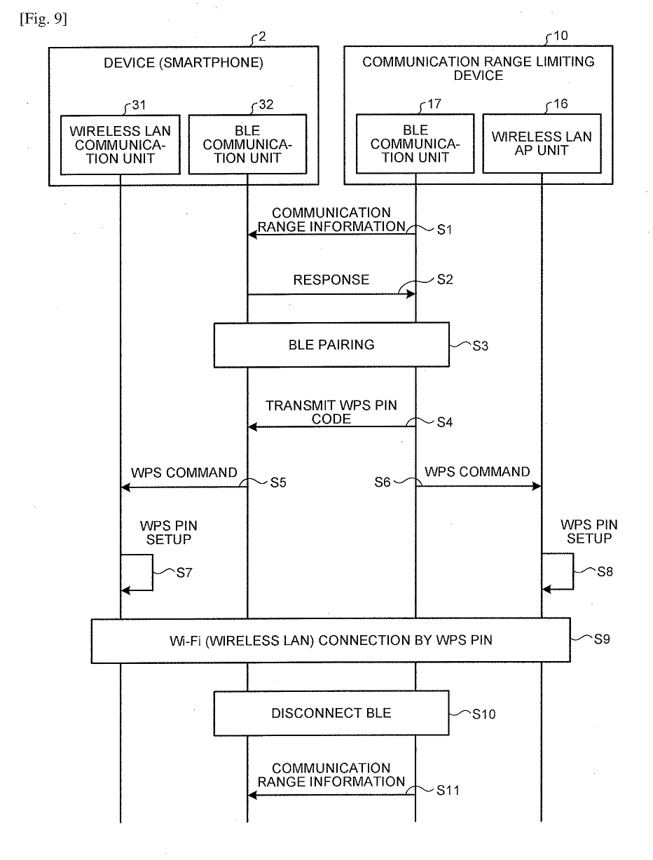

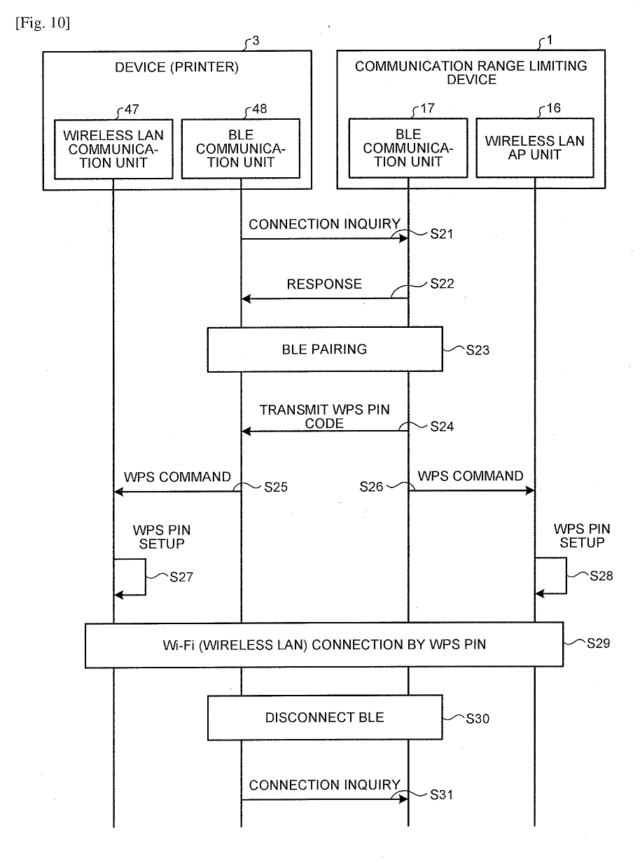

FIG. 8 is a block diagram illustrating functions achieved by the CPU 41 of the printer device 3 when the CPU 41 operates in accordance with the communication control program. As illustrated in FIG. 8, the CPU 41 of the printer device 3 operates in accordance with the communication control program to thereby function as a print module 85, a wireless LAN communication control module 86, and a BLE communication control module 87. The print module 85 achieves a function to control the printer mechanism 45 to print an image, text, or the like requested by the smartphone 2.

It is noted that the following description of this example assumes that the elements from the print module 85 to the BLE communication control module 87 are achieved as software functions. The elements from print module 85 to the BLE communication control module 87 may nonetheless be achieved in part or in whole by an integrated circuit (IC) or by hardware.

The communication control program of the printer device 3 may be recorded and provided in a computer-readable recording medium such as a CD-ROM and a flexible disk (FD) as an installable or executable file. The communication control program of the printer device 3 may even be recorded and provided in a computer-readable recording medium such as a CD-R, a DVD, a Blu-ray disc (registered trademark), and a semiconductor memory. The communication control program of the printer device 3 may still be provided by being installed via a network such as, the Internet. The communication control program of the printer device 3 may still be embedded and provided in a ROM of a device, for example.

Outline of Basic Operations of Wireless LAN Communication scheme

In the wireless LAN communication scheme, the outer ellipse indicated by the solid line in FIG. 1 represents a wireless LAN communication-enabled range (the wireless LAN communication area 5) formed by the wireless LAN AP unit 16 of the communication range limiting device 1. The smartphone 2, the printer device 3, and the projector device 4 are disposed inside this wireless LAN communication area 5.

The smartphone 2 communicates with the printer device 3, the projector device 4, and other peripheral devices having the wireless LAN communication function to thereby be capable of remote control of, for example, printing of a desired image, text, or the like and projection of an image or the like via the wireless LAN.

The printer device 3, the projector device 4, and other peripheral devices include the wireless LAN communication units 47 and 67 and the BLE communication units 48 and 68. This arrangement enables BLE communication with the BLE communication unit 17 of the communication range limiting device 1. As indicated by the dotted-line ellipse in FIG. 1, however, the BLE communication area 6 is narrower than the wireless LAN communication area 5. Thus, whereas the BLE communication is enabled between each of the smartphone 2 and the printer device 3 that are disposed inside the BLE communication area 6, and the communication range limiting device 1, the BLE communication is disabled between the projector device 4 disposed outside the BLE communication area 6 and the communication range limiting device 1.

Specifically, the wireless LAN communication scheme performs the wireless LAN setup through the BLE communication as will be described later. As a result, only the smartphone 2 and the printer device 3 that are capable of the BLE communication can actually perform communication using the wireless LAN. The wireless LAN setup cannot be performed for the projector device 4 that is incapable of the BLE communication, even though the projector device 4 is disposed inside the wireless LAN communication area 5, so that the wireless LAN communication is disabled with the projector device 4.

Basic Connection Operation with Respect to Smartphone

FIG. 9 is a sequence diagram illustrating that the smartphone 2 that has moved into the BLE communication area 6 within the wireless LAN communication area 5 establishes a wireless LAN communication line. The device connecting module 75 of the communication range limiting device 1 transmits, for example, an advertisement packet through three advertisement channels from the BLE communication control module 79 via the BLE communication unit 17 to thereby notify a peripheral device of presence of the communication range limiting device. The advertisement packet includes communication range information that indicates the BLE communication area 6. Step S1 denotes the transmission of the advertisement packet including the communication range information that indicates the BLE communication area 6.

When the smartphone 2 is located within the BLE communication area 6, the BLE communication unit 32 of the smartphone 2 receives the advertisement packet (the communication range information) that has been transmitted from the communication range limiting device 1. By referring to the received communication range information, the smartphone 2 determines whether the smartphone 2 is located within the BLE communication area 6. A result of this determination is transmitted to the communication range limiting device 1 through the BLE communication as a response denoted by Step S2. If the smartphone 2 is located within the BLE communication area 6, the BLE communication unit 32 of the smartphone 2 and the BLE communication unit 17 of the communication range limiting device 1 perform pairing for the BLE communication (BLE pairing) at Step S3. The BLE pairing enables the BLE communication between the smartphone 2 and the communication range limiting device 1.

When the BLE pairing is completed, the device connecting module 75 of the communication range limiting device 1 uses the BLE communication to transmit to the smartphone 2 at Step S4 a PIN code (unique identification information) of the WPS system that facilitates wireless LAN connection and is standardized by Wi-Fi Alliance. Additionally, the device connecting module 75 of the communication range limiting device 1 transfers to the wireless LAN AP unit 16, at Step S6, the PIN code that has been transmitted to the smartphone 2, thereby issuing a command to prepare for starting communication by the WPS system. The wireless LAN AP unit 16 of the communication range limiting device 1 performs setup for the WPS system using the PIN code transmitted to the smartphone 2 at Step S8.

The BLE communication unit 32 of the smartphone 2, having received the PIN code of the WPS system from the communication range limiting device 1, transfers at Step S5 the received PIN code to the wireless LAN communication unit 31, thereby issuing a command to prepare for starting communication by the WPS system. At Step S7, the wireless LAN communication unit 31 performs setup for the WPS system using the PIN code transferred from the communication range limiting device 1. This establishes Wi-Fi connection (wireless LAN connection) between the smartphone 2 and the communication range limiting device 1 by the WPS system through the use of the PIN code.

As described above, the wireless LAN communication scheme automatically completes the Wi-Fi connection (wireless LAN connection) when the smartphone 2 is located within the BLE communication area 6 of the communication range limiting device 1. This automatic connection establishment relieves the user of setup knowledge about the wireless LAN and a troublesome operation to input the PIN code. In addition, encrypted information is transmitted and received among different devices in BLE communication, so that the PIN code can be transmitted and received with security.

Next, at Step S10, the BLE communication control module 83 of the smartphone 2 and the BLE communication control module 79 of the communication range limiting device 1 temporarily disconnect the BLE communication in order to enable connection of a new device. Thereafter, at Step S11, the device connecting module 75 of the communication range limiting device 1 transmits an advertisement packet that includes the communication range information indicating the BLE communication area 6, as described previously with reference to Step S1. The device connecting module 75 of the communication range limiting device 1 then attempts to establish a wireless LAN communication line with a device such as the smartphone 2 located in the BLE communication area 6 through the BLE communication as described previously.

Basic Connection Operation with Respect to Printer Device

FIG. 10 is a sequence diagram illustrating that the printer device 3 disposed in the BLE communication area 6 within the wireless LAN communication area 5 establishes a wireless LAN communication line. The printer device 3 as a peripheral device effectively functions when it receives a print request from a device that makes a print request, such as the smartphone 2. Thus, to establish wireless LAN communication with the printer device 3, preferably, the smartphone 2 or the like that controls the printer device 3 has previously been connected to the wireless LAN. The sequence diagram illustrated in FIG. 10 assumes that the smartphone 2 has already been connected to the wireless LAN (see the description for FIG. 9). The sequence diagram illustrated in FIG. 10 starts its process with Step S21 when the transmission of an advertisement packet is enabled by the temporary disconnection of the BLE communication between the smartphone 2 and the communication range limiting device 1 at Step S10 illustrated in FIG. 9.

The printer device 3 is a stationary device disposed in the BLE communication area 6 of the communication range limiting device 1. At Step S21, the printer device 3 transmits, at regular intervals and through the abovementioned three advertisement channels, an advertisement packet that includes connection inquiry information for inquiring whether a device to make a print request such as the smartphone 2 has been connected to the wireless LAN to the communication range limiting device 1 via the BLE communication unit 48. The peripheral device connecting module 76 of the communication range limiting device 1 illustrated in FIG. 6 transmits, at Step S22 to the printer device 3 via the BLE communication unit 17, a response that indicates whether a device to make a print request has been connected.

If a device to make a print request such as the smartphone 2 has been connected to the wireless LAN, the peripheral device connecting module 76 of the communication range limiting device 1 and the BLE communication unit 48 of the printer device 3 perform pairing for the BLE communication (BLE pairing) at Step S23. The BLE pairing enables the BLE communication between the printer device 3 and the communication range limiting device 1.

When the BLE pairing is completed, the peripheral device connecting module 76 of the communication range limiting device 1 transmits to the printer device 3 at Step S24 a PIN code of the WPS system that facilitates wireless LAN connection and is standardized by Wi-Fi Alliance. Additionally, the communication range limiting device 1 transfers, at Step S26 to the wireless LAN AP unit 16, the PIN code that has been transmitted to the printer device 3, thereby issuing a command to prepare for starting communication by the WPS system. The wireless LAN AP unit 16 of the communication range limiting device 1 performs setup for the WPS system using the PIN code transmitted to the printer device 3 at Step S28.

The BLE communication unit 48 of the printer device 3, having received the PIN code of the WPS system from the communication range limiting device 1, transfers at Step S25 the received PIN code to the wireless LAN communication unit 47, thereby issuing a command to prepare for starting communication by the WPS system. At Step S27, the wireless LAN communication unit 47 performs setup for the WPS system using the PIN code transferred from the BLE communication unit 48. This establishes Wi-Fi connection (wireless LAN connection) between the printer device 3 and the communication range limiting device 1 by the WPS system through the use of the PIN code.

Next, at Step S30, the BLE communication unit 48 of the printer device 3 and the BLE communication unit 17 of the communication range limiting device 1 temporarily disconnect the BLE communication in order to enable connection of a new device. Thereafter, at Step S31, the BLE communication unit 48 of the printer device 3 transmits an advertisement packet that includes the connection inquiry information, as described previously with reference to Step S21. When a device to make a print request is connected to the wireless LAN, the communication range limiting device 1 attempts to establish a wireless LAN communication line with the printer device 3 located in the BLE communication area 6 through the BLE communication as described previously.

Print Operation

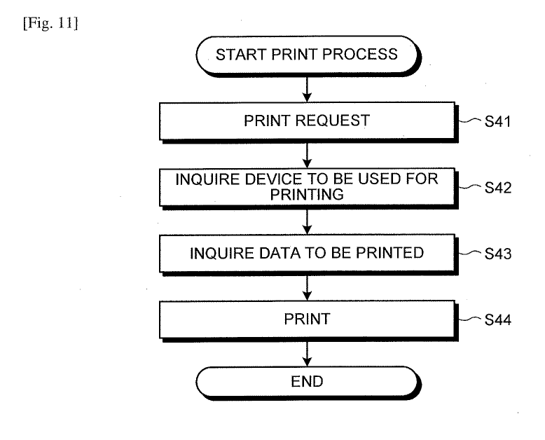

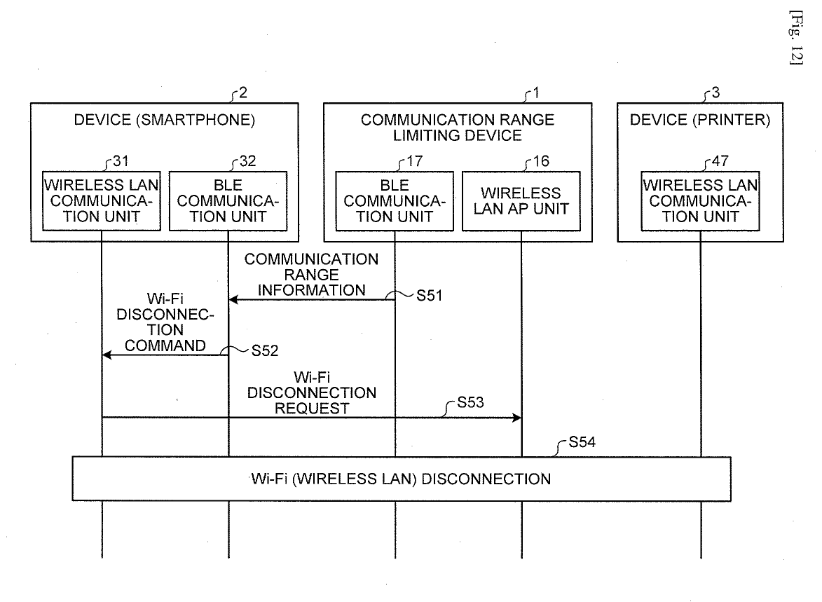

The flowchart illustrated in FIG. 11 illustrates that the smartphone 2 connected to the wireless LAN remotely controls and causes the printer device 3 to produce a printed matter. As described previously, the mutual connection established between the smartphone 2 and the printer device 3 via the wireless LAN communication units 31 and 47 in the wireless LAN enables remote control of the printer device 3 by the smartphone 2.

When using the smartphone 2 to remotely control the printer device 3, the user operates to start a print application program stored in memory of, for example, the ROM 22 of the smartphone 2. When the print application program is started to operate, the print request module 81 of the smartphone 2 illustrated in FIG. 7 makes a print request to the printer device 3 via the wireless LAN communication control module 82 and the wireless LAN communication unit 31 at Step S41. The print module 85 of the printer device 3 illustrated in FIG. 8, upon receipt of the print request, inquires a device to be used for printing of the smartphone 2 via the wireless LAN communication unit 47 at Step S42. If data stored in the smartphone 2 is to be printed, the user notifies the printer device 3 that the device to be used for printing is the smartphone 2 through the wireless LAN communication. If an image projected with the projector device 4, for example, is to be printed, the user notifies the printer device 3 that the device to be used for printing is the projector device 4 through the wireless LAN communication.

At Step S43, the print module 85 of the printer device 3 inquires data to be printed of the smartphone 2 through the wireless LAN communication. If data, such as an image or text, stored in the smartphone 2 is to be printed, the user notifies the printer device 3 that the data to be printed is data stored in the smartphone 2 through the wireless LAN communication. Alternatively, if an image or other data projected with the projector device 4 is to be printed, the user notifies the printer device 3 that the data to be printed is data projected with the projector device 4 through the wireless LAN communication. Finally, at Step S44, the print module 85 of the printer device 3 executes printing by acquiring the data specified by the user from the device specified by the user (the smartphone 2 or the projector device 4) through the wireless LAN communication.

Device Disconnecting Operation

FIG. 12 is a sequence diagram illustrating that the wireless LAN communication line (and the BLE communication line) is disconnected when the smartphone 2 connected in the BLE communication area 6 to the printer device 3 through the wireless LAN moves out of the BLE communication area 6. At Step S51, as described previously, the communication range information that indicates the communication range corresponding to the BLE communication area 6 is transmitted from the BLE communication unit 17 of the communication range limiting device 1 to the smartphone 2 through the BLE communication. The smartphone 2 compares the position of the communication range limiting device detected by, for example, its global positioning system (GPS) with the BLE communication area 6 indicated by the communication range information. The smartphone 2, when having detected that the communication range limiting device is outside the BLE communication area 6, instructs the wireless LAN communication unit 31 to disconnect the wireless LAN (Wi-Fi disconnection command) at Step S52.

It is noted that, in this example, the communication range limiting device 1 transmits the communication range information to the smartphone 2 and the smartphone 2 compares the current position of the communication range limiting device with the BLE communication area 6 indicated by the communication range information to thereby detect withdrawal from the BLE communication area 6. Another arrangement may nonetheless be made in which the smartphone 2 transmits the current position of the communication range limiting device detected with the GPS or the like to the communication range limiting device 1 through the BLE communication and the communication range limiting device 1 compares the current position of the smartphone 2 with the BLE communication area 6 to thereby detect withdrawal of the device such as the smartphone 2 from the BLE communication area 6. In this arrangement, the withdrawal detecting module 77 illustrated in FIG. 6 is to detect the withdrawal of the device such as the smartphone 2 from the BLE communication area 6.

The wireless LAN communication unit 31 of the smartphone 2, when instructed by the BLE communication unit 32 to disconnect the wireless LAN, requests the communication range limiting device 1 to disconnect the wireless LAN using the wireless LAN communication at Step S53. The communication range limiting device 1, upon receipt of the wireless LAN disconnection request, disconnects the wireless LAN communication line associated with the device that has made the wireless LAN disconnection request as indicated by Step S54. This disconnects the wireless LAN communication line for not only the smartphone 2, but also the printer device 3.

To re-establish the wireless LAN communication line after it has been disconnected, the communication range limiting device 1 renews the PIN code. As a result, when the smartphone 2 that has moved out of the BLE communication area 6 re-enters the BLE communication area 6, the wireless LAN communication line is established using a PIN code different from the previous one.

As described above, the wireless LAN communication scheme can automatically disconnect the wireless LAN communication line and the BLE communication line when the smartphone 2 moves out of the BLE communication area 6. This capability allows the range in which the smartphone 2 can be connected to the wireless LAN to be limited to a predetermined range (within the BLE communication area 6). In addition to the smartphone 2 that has moved out of the BLE communication area 6, the wireless LAN communication scheme further disconnects the wireless LAN communication line of the printer device 3 that has been communicating with the smartphone 2. This arrangement prevents an inconvenience in which the connection of the printer device 3 to the wireless LAN communication line that is no longer used as a result of the disconnection of the wireless LAN communication line with respect to the smartphone 2 continues to exist wastefully, so that an even greater communication security can be achieved. Specifically, even a user who is not authorized to connect to a local network such as an in-house LAN is temporarily and simply allowed to have his or her device connected to the local network and to use his or her device, while security of the local network is ensured.

Additionally, the PIN code is renewed when the wireless LAN communication line that has previously been disconnected is to be re-established. This arrangement prevents the following illegal act: the smartphone 2 that has moved out of the BLE communication area 6 reuses the PIN code used in the last connection to thereby attempt to intercept another device through the wireless LAN communication.

When the smartphone 2 moves out of the BLE communication area 6, the wireless LAN communication line is disconnected of the printer device 3 that has been communicating with the smartphone 2 as well as the smartphone 2. This arrangement prevents an inconvenience in which the connection of the printer device 3 to the wireless LAN communication line that is no longer used as a result of the disconnection of the wireless LAN communication line with respect to the smartphone 2 continues to exist wastefully, so that an even greater communication security can be achieved.

It is noted that a public key may be delivered in place of the PIN code of the WPS system that is delivered from the communication range limiting device 1 to a device such as the smartphone 2 through the BLE communication when the wireless LAN communication line is to be established. The wireless LAN communication line may be established by delivering, in place of the PIN code of the WPS system, a public key according to the Diffie-Hellman key exchange method, for example. In this case, the public key is transmitted and received within the BLE communication area 6, so that a wireless LAN administrator can monitor the transmission and reception of the public key. This approach clarifies, for example, the specific device that transmits the public key, the specific device that receives the public key, and the specific user. Thus, illegal communications by an illegal user and an illegal device, what is called spoofing, can be prevented. In addition, when the wireless LAN communication line that has previously been disconnected is to be re-established, preferably, a new public key different from the previous one is used as with the PIN code described previously.

Additionally, the PIN code or the public key may be transmitted by sound (an acoustic output propagating through a space) from the communication range limiting device 1 to a device such as the smartphone 2 or the printer device 3. Because the acoustic output offers spatial transmissibility poorer than that of the radio waves used in the BLE communication, the transmission and reception range of the PIN code, for example, can be limited to a range over which sound can be transmitted and received between devices. Thus, the PIN code or the like is transmitted and received in a narrow range which a system administrator, for example, can monitor. As a result, illegal communications by an illegal user and an illegal device, what is called spoofing, mentioned previously can be prevented even more reliably.

Additionally, presence of a device within the BLE communication area 6 may be monitored using received signal strength indication (RSSI) of the BLE communication unit 17 instead of the communication range information. By setting the received signal strength indications of the BLE communication regarded as an exit RSSI area and an entrance RSSI area to desired levels, the range over which connection can be made to the wireless LAN (range of the entrance RSSI area) can be dynamically adjusted within the BLE communication area 6.

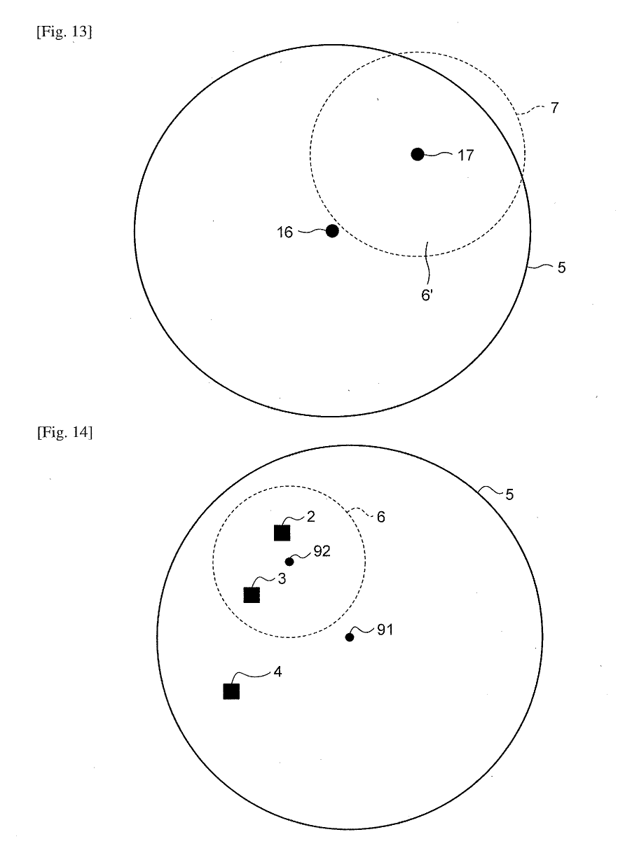

The above-described example encompasses the BLE communication area within the wireless LAN communication area. Nonetheless, as illustrated, for example, in FIG. 13, at least part of the BLE communication area may be disposed outside the wireless LAN communication area. In FIG. 13, a BLE communication area 6′ represents an area in which the wireless LAN communication line can be established. This is because in a BLE communication area 7 outside the wireless LAN communication area, the setup for performing the wireless LAN communication cannot be made, though communication range information can be received through BLE communication. The condition illustrated in FIG. 13 is possible, for example, in a case in which the wireless LAN AP unit 16 and the BLE communication unit 17 are disposed at different positions and in a case in which the communication-enabled range protrudes in one direction because of communication directivity concerned.

### First Embodiment

A wireless LAN communication scheme according to a first embodiment automatically forms, inside a wireless local area network (wireless LAN), a wireless network having a communication range narrower than that of the LAN (e.g., a wireless personal area network (wireless PAN)). Specifically, when a distance between a device corresponding to the wireless LAN and the wireless PAN, and the wireless PAN inside the wireless LAN is smaller than a predetermined value, authentication information and setup information for wireless LAN setup are transmitted to the device using wireless PAN communication. This establishes communication connection to the wireless LAN simply (automatically). When the distance between the device and the wireless PAN inside the wireless LAN is greater than the predetermined value, processing to disconnect the wireless LAN communication line is performed to thereby no longer enable communication connection with respect to the wireless LAN.

The foregoing arrangements enable use of the wireless LAN with security. Additionally, the foregoing arrangements make the wireless LAN available for use only in a limited communication range for a user's wireless LAN device within the wireless LAN communication range. Thus, even a user who is not authorized to connect to a local network such as an in-house LAN, for example, is temporarily and simply allowed to have his or her device connected to the local network and to use his or her device, while security of the local network is ensured.

The following describes an overview of the wireless LAN communication scheme according to the first embodiment with reference to the relevant drawings. FIG. 14 is a schematic diagram for illustrating the overview of the wireless LAN communication scheme according to the first embodiment. In FIG. 14, a first communication establishing device 91 as an exemplary first communication unit forms a first communication area 5 that is the wireless LAN communication area. Similarly, a second communication establishing device 92 as an exemplary second communication unit forms, in the first communication area 5, a second communication area 6 that is narrower than the first communication area 5. Specifically, the first communication area 5 encompasses the second communication area 6.

In the example illustrated in FIG. 1, a first device 2 and a second device 3 that are capable of communication connection with the first communication area 5 and the second communication area 6 are disposed inside the second communication area 6. In addition, in the example illustrated in FIG. 1, a third device 4 is disposed at a position, though it is inside the first communication area 5, outside the second communication area 6. In the wireless LAN communication scheme of this embodiment, communication of the second communication device 9 can be established between the first device 2 and the second device 3 only within the first communication area 5. The third device 4 is unable to establish communication of the second communication device 92.

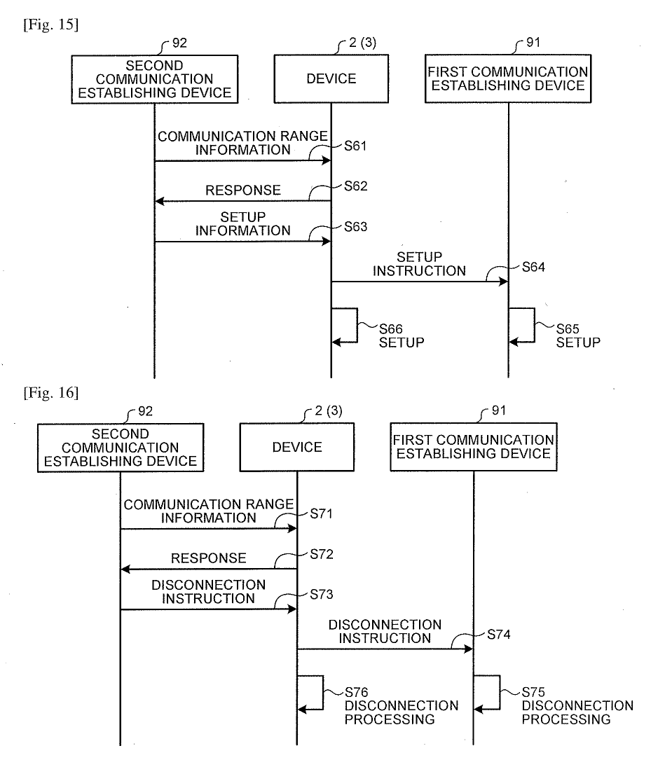

FIG. 15 is a sequence diagram illustrating that the first device 2 and the second device 3 establishes a communication line. The sequence diagram illustrated in FIG. 15 depicts the first communication establishing device 91, the second communication establishing device 92, the first device 2, and the second device 3. Because the first device 2 and the second device 3 perform the same processing, FIG. 15 illustrates only one device as a representative. The following basically describes operations of only the first device 2.

At Step S61, the second communication establishing device 92 that forms the second communication area 6 transmits communication range information indicating the second communication area 6 to the first device 2 (and the second device 3). The first device 2, having received the communication range information, recognizes that the first device 2 is located within the second communication range 6 and, at Step S62, transmits response information to the second communication establishing device 92.

The second communication establishing device 92, having received the response information from the first device 2, transmits setup information for establishing communication of the first communication area 5 to the first device 2 at Step S63. At Step S64, the first device 2 uses the received setup information to transmit a communication setup instructing signal to the first communication establishing device 91. Next, at Step S65, the first communication establishing device 91 performs communication setup, while the first device 2 and the second device 3 perform communication setup at Step S66. The performance of these steps establishes a communication line between the first device 2 and the second device 3 in the second communication area 6 within the first communication area 5.

As described above, the wireless LAN communication scheme of this embodiment can readily perform setup by acquiring setup information of another communication establishing device (the second communication establishing device 92) within a limited communication area (the first communication area 5). It is noted that, when the first communication establishing device 91 and the second communication establishing device 92 are an identical module, the second communication establishing device 92 may transmit the communication setup instructing signal to the first communication establishing device 91.

FIG. 16 is a sequence diagram illustrating that a communication line is disconnected when the first device 2 (or the second device 3) moves out of the second communication area 6. At Step S71 in FIG. 16, the second communication establishing device 92 transmits communication range information indicating the second communication area 6 to the first device 2 (and the second device 3) at predetermined timing.

The first device 2 and the second communication establishing device 92 detect their current positions through, for example, the global positioning system (GPS). The first device 2 compares the communication range information received from the second communication establishing device 92 with the current position information detected through, for example, the GPS. Next, at Step S72, the first device 2 transmits to the second communication establishing device 92 a response signal that indicates whether the current position is located within the second communication area 6 of the second communication establishing device 92.

If the response signal that indicates that the current position is outside the second communication area 6 is received from the first device 2, the second communication establishing device 92 transmits a disconnection instructing signal for the communication line of the second communication establishing device 92 to the first device 2 at Step S73. It is noted that an area over which radio waves can cover the second communication establishing device 92 and the first device 2 is wider than the second communication area 6 of the second communication establishing device 92. This results in the first device 2 and the second device 3 being capable of communicating with the second communication establishing device 92 even when the first device 2 and the second device 3 are located outside the second communication area 6.

The first device 2, upon receipt of the communication line disconnection instructing signal from the second communication establishing device 92, transmits a communication line disconnection instructing signal to the first communication establishing device 91 at Step S74. Next, at Steps S75 and S76, the first device 2 performs communication line disconnection processing for the first communication establishing device 91. The performance of the processing disconnects the communication line of the first communication establishing device 91 between the first device 2 and the second device 3. Additionally, having received the communication line disconnection instructing signal from the first device 2, the first communication establishing device 91 performs communication line disconnection processing. It is noted that, when the first communication establishing device 91 and the second communication establishing device 92 are an identical module, the second communication establishing device 92 may transmit the communication line disconnection instructing signal to the first communication establishing device 91.

As such, the communication between the first device 2 and the second device 3 can be limited within the second communication area 6 inside the first communication area 5 by the first communication establishing device 91. Thus, even a user who is not authorized to connect to a communication line with respect to the first communication area 5 is temporarily and simply allowed to have his or her first device 2 (or second device 3) connected to the network and to use his or her first device 2 (or second device 3), while security of the network is ensured.

The following description assumes that the local area network is exemplarily a wireless LAN and the personal area network is exemplarily a Bluetooth PAN. It is noted that non-contact wireless communication (Near Field Communications (NFC)) may, for example, be used instead of the Bluetooth. In this case, too, effects to be described later can be achieved likewise. See the description that follows.

### Second Embodiment

The following describes a wireless LAN communication scheme according to a second embodiment. The wireless LAN communication scheme in the second embodiment delivers a public key in place of the PIN code of the WPS system that is delivered from the communication range limiting device 1 to a device such as the smartphone 2 through the BLE communication when the above-described wireless LAN communication line is to be established.

Specifically, at Step S24 in FIG. 9 and Step S24 in FIG. 10, the communication range limiting device 1 delivers the PIN code of the WPS system to a device such as the smartphone 2. With the wireless LAN communication scheme according to the second embodiment, in place of the PIN code of the WPS system, a public key according to the Diffie-Hellman key exchange method, for example, is to be delivered. The following describes these different features and omits similarities found in the first embodiment.

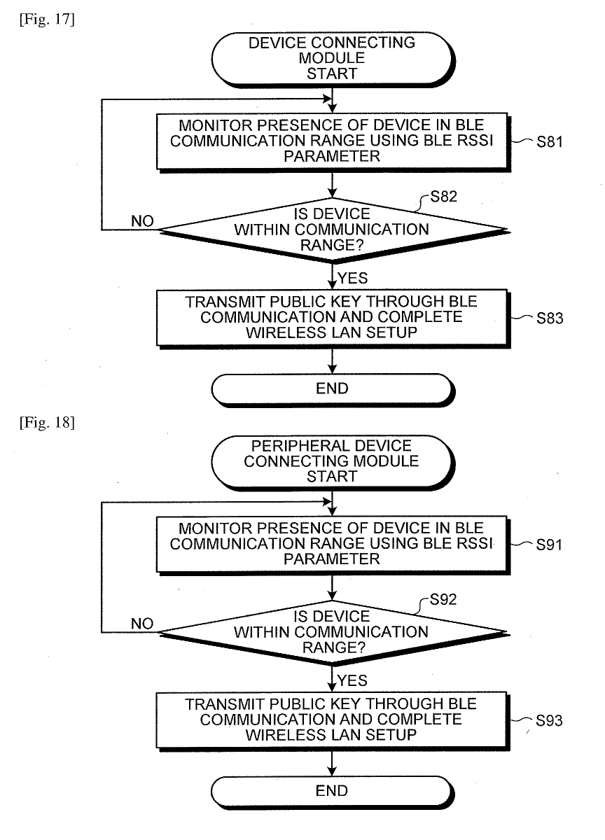

FIG. 17 is a flowchart illustrating that the device connecting module 75 of the communication range limiting device 10 delivers a public key to the smartphone 2 to thereby attempt to establish a wireless LAN connection of the WPS system. In the flowchart illustrated in FIG. 17, at Steps S81 and S82, the device connecting module 75 of the communication range limiting device 1 monitors presence of the device (the smartphone 2) in the BLE communication area 6 using received signal strength indication (RSSI) of the BLE communication unit 17 to be described with reference to a fourth embodiment. RSSI stands for received signal strength indication. It is noted that the communication range information described with reference to the first embodiment may be used instead of the RSSI.

The device connecting module 75, when having determined that the smartphone 2 is located within the BLE communication area 6 (Yes at Step S82), performs Step S83. At Step S83, the device connecting module 75 transmits the public key instead of the PIN code to the smartphone 2 through the BLE communication, as described with reference to Step S4 in FIG. 9 and Step S24 in FIG. 10.

The wireless LAN AP unit 16 on the side of the communication range limiting device 1 decrypts the public key using a private key corresponding to the public key transmitted to the smartphone 2 side and, using the decryption result, performs setup of the wireless LAN.

On the smartphone 2 side, the wireless LAN communication unit 31 decrypts the public key using the private key corresponding to the public key received from the communication range limiting device 1 and, using the decryption result, performs setup of the wireless LAN.

The foregoing steps establish a wireless LAN communication line between the communication range limiting device 1 and the smartphone 2, enabling BLE communication with another device in the BLE communication area 6 as described previously.

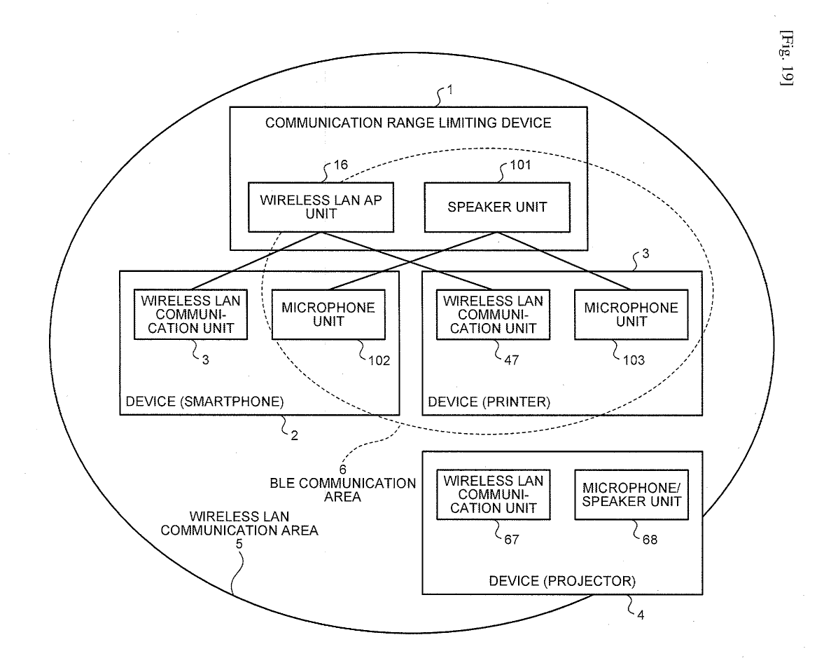

Similarly, FIG. 18 is a flowchart illustrating that the peripheral device connecting module 76 of the communication range limiting device 10 delivers a public key to the printer device 3 to thereby attempt to establish a wireless LAN connection of the WPS system. In the flowchart illustrated in FIG. 18, at Steps S91 and S92, the peripheral device connecting module 76 of the communication range limiting device 1 monitors presence of a peripheral device (the printer device 3) in the BLE communication area 6 using received signal strength indication (RSSI) of the BLE communication unit 17. It is noted that the communication range information described with reference to the first embodiment may be used instead of the RSSI, as in the above case.

When the connection of the smartphone 2 to the wireless LAN is completed as described above and the presence of the printer device 3 in the BLE communication area 6 is detected (Yes at Step S92), the peripheral device connecting module 76 performs Step S93. At Step S93, the peripheral device connecting module 76 transmits the public key, in place of the PIN code, to the printer device 6, as described previously with reference to Step S24 in FIG. 9 and Step S24 in FIG. 10.

The wireless LAN AP unit 16 on the side of the communication range limiting device 1 decrypts the public key using a private key corresponding to the public key transmitted to the smartphone 2 side and, using the decryption result, performs setup of the wireless LAN.

On the printer device 3 side, the wireless LAN communication unit 31 decrypts the public key using the private key corresponding to the public key received from the communication range limiting device 1 and, using the decryption result, performs setup of the wireless LAN.

The foregoing steps connect the smartphone 2 and the printer device 3 to the wireless LAN as described above, enabling BLE communication between the smartphone 2 and the printer device 3.

The wireless LAN communication scheme according to the second embodiment as described above involves transmission and reception of a public key in the BLE communication area 6. This enables a wireless LAN administrator to monitor the transmission and reception of the public key. As a result, for example, the specific device that transmits the public key, the specific device that receives the public key, and the specific user are clearly identifiable. Thus, illegal communications by an illegal user, an illegal device, and the like, what is called spoofing, can be prevented. Additionally, the same effects as those achieved by the first embodiment described previously can be achieved.

As described with reference to FIG. 11, when the wireless LAN communication line that has previously been disconnected is to be re-established, a new public key different from the previous one is used as with the PIN code described previously.

### Third Embodiment

The following describes a wireless LAN communication scheme according to a third embodiment. The wireless LAN communication scheme according to each of the above-described embodiments transmits a PIN code or a public key from the communication range limiting device 10 to the side of the device such as the smartphone 2 and the printer device 3. In contrast, the wireless LAN communication scheme according to the third embodiment transmits the PIN code or the public key by sound (an acoustic output propagating through a space) from the communication range limiting device 10 to the side of the device such as the smartphone 2 and the printer device 3. The following description assumes that the PIN code is exemplarily delivered. Additionally, the following describes these different features and omits similarities found in each of the above-described embodiments.

FIG. 19 is a system configuration diagram illustrating the wireless LAN communication scheme according to the third embodiment. As illustrated in FIG. 19, the communication range limiting device 1 in the wireless LAN communication scheme according to the third embodiment includes a speaker unit 101. The smartphone 2 includes a microphone unit 102. The printer device 3 includes a microphone unit 103. The projector device 4 includes a microphone/speaker unit 68.

The communication range limiting device 1 outputs a PIN code by sound having a frequency close to an upper limit audio frequency with a range of frequencies, typically from 18,000 Hz to 20,000 Hz, via the speaker unit 101. Specifically, an acoustic PIN code is produced (output) from the speaker unit 101 of the communication range limiting device 1.

The device side such as the smartphone 2 or the printer device 3 collects the acoustic PIN code using, for example, the microphone unit 102 or the microphone unit 103. The smartphone 2 or the printer device 3 analyzes the collected sound to thereby acquire a PIN code and uses the PIN code for connection to the above-described wireless LAN communication line.

The acoustic output offers spatial transmissibility poorer than that of the radio waves used in the BLE communication. This characteristic allows the range over which the acoustic output is transmitted to be set to a range in which sound can be transmitted and received between, for example, the speaker unit 101 and the microphone unit 102 in the wireless LAN communication scheme in the third embodiment. Specifically, with the wireless LAN communication scheme in the third embodiment, the PIN code can be transmitted and received in an even narrower range than in any of the embodiments described above. Thus, in the wireless LAN communication scheme in the third embodiment, the PIN code or the like is transmitted and received in a range over which, for example, a system administrator can monitor. Thus, illegal communications by an illegal user and an illegal device, what is called spoofing, mentioned previously can be prevented even more reliably and the same effects as those that can be achieved by each of the above-described embodiments can be achieved.

Additionally, when a device already includes a microphone unit, as with the microphone unit for telephone communication provided for the smartphone 2, the wireless LAN communication scheme in the third embodiment can be achieved by using the existing configuration of the smartphone 2 or the like.

It is noted that the configuration in which the PIN code or the like is transmitted by sound entails difficulty in detecting a device that moves out of the BLE communication area 4. Thus, the wireless LAN communication scheme in the third embodiment updates the PIN code transmitted by sound at regular intervals. This arrangement disables updating of the PIN code after the device has moved out of the BLE communication area 6, so that illegal connection to the wireless LAN using the previous PIN code can be prevented.

### Fourth Embodiment

The following describes a wireless LAN communication scheme according to a fourth embodiment. The wireless LAN communication scheme according to each of the above-described embodiments uses the communication range information to detect presence of a device in the BLE communication area 4. In contrast, the wireless LAN communication scheme according to the fourth embodiment uses the received signal strength indication (RSSI) of the BLE communication unit 17 to monitor presence of a device inside the BLE communication area 6. The following describes these different features and omits similarities found in each of the above-described embodiments.

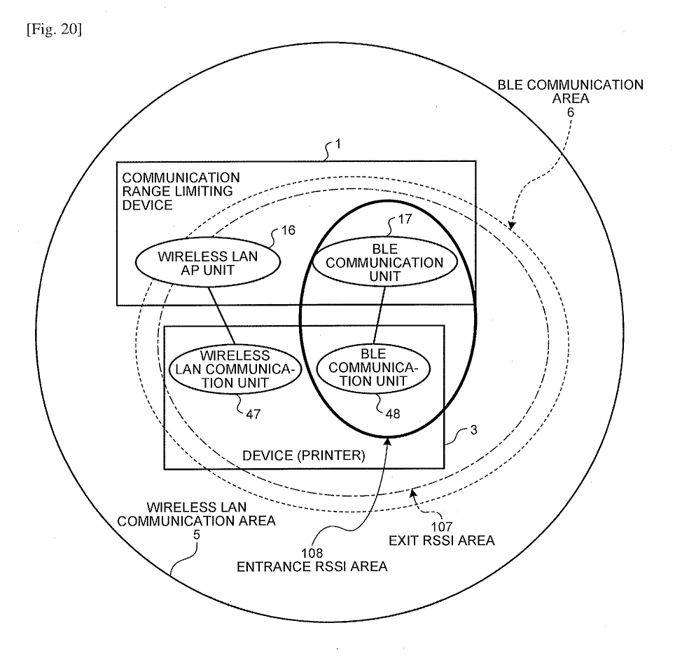

FIG. 20 is a system configuration diagram illustrating the wireless LAN communication scheme according to the fourth embodiment. The wireless LAN communication scheme according to the fourth embodiment has an entrance RSSI area 108 indicated by the thick-line circular range in FIG. 20 inside the BLE communication area 6 indicated by the dotted-line circular range in FIG. 20. The entrance RSSI area 108 represents a received signal strength range in which the device is detected to be located within the BLE communication area 6. Additionally, the wireless LAN communication scheme according to the fourth embodiment further has an exit RSSI area 107 indicated by a dash-single-dot-line circular range in FIG. 20. The exit RSSI area 107 represents a received signal strength range in which the device is detected to have moved out of the BLE communication area 6.

To state the foregoing differently, in the wireless LAN communication scheme according to the fourth embodiment, the entrance RSSI area 108 is set to be a range having a received signal strength level of BLE communication with the device within the BLE communication area 6 equal to or higher than a predetermined level. Additionally, in the wireless LAN communication scheme according to the fourth embodiment, the exit RSSI area 107 is set to be a range having a received signal strength level of BLE communication with the device within the BLE communication area 6 lower than the predetermined level.

In the wireless LAN communication scheme according to the fourth embodiment having arrangements as described above, when a device such as the smartphone 2 moves into the BLE communication area 6 indicated by the dotted-line circular range in FIG. 20, the BLE communication is started between the communication range limiting device 1 and the smartphone 2 as described previously. When the smartphone 2 moves further to be located inside the entrance RSSI area 108, the received signal strength of the BLE communication becomes equal to or higher than the predetermined received signal strength level. Upon detecting that the received signal strength of the BLE communication is equal to or higher than the predetermined received signal strength level, the communication range limiting device 1 determines that the device such as the smartphone 2 has moved into the entrance RSSI area 108. The communication range limiting device 1 then transmits the PIN code or the public key to the device such as the smartphone 2 that has moved to the entrance RSSI area 108 as described previously, to thereby perform the wireless LAN connection setup (see FIGS. 8, 9, 17, and 18).

When the smartphone 2 moves from the entrance RSSI area 108 to the exit RSSI area 107, the received signal strength of the BLE communication becomes lower than the predetermined received signal strength level. Upon detecting that the received signal strength of the BLE communication is lower than the predetermined received signal strength level, the communication range limiting device 1 determines that the device such as the smartphone 2 has, moved into the exit RSSI area 107. The communication range limiting device 1 then disconnects the wireless LAN communication line and the BLE communication line that have been connected to the device such as the smartphone 2 that moved into the exit RSSI area 107 as described previously (see FIG. 11).

It is here noted that, in the wireless LAN communication scheme according to the fourth embodiment, a first threshold and a second threshold different from the first threshold are set for the communication range limiting device 10. The first threshold is used for determining entrance of the device in the entrance RSSI area 108. The second threshold is used for determining exit of the device from the entrance RSSI area 108.

When the received signal strength of the BLE communication is equal to or higher than the first threshold, the communication range limiting device 1 determines that the smartphone 2 has moved into (entered) the entrance RSSI area 108. When the received signal strength of the BLE communication is lower than the second threshold, the communication range limiting device 1 determines that the smartphone 2 has moved out of (exited) the entrance RSSI area 108.

Determining movement of the smartphone 2 to and from the entrance RSSI area 108 on a basis of a single threshold may involve variations in the result of determination of entrance and exit when the smartphone 2 is stationary in a boundary between the entrance RSSI area 108 and the exit RSSI area 107. Using a unique threshold for determining each of the entrance and exit, however, allows a boundary value between the entrance RSSI area 108 and the exit RSSI area 107 to have what is called a Schmitt characteristic. This approach can prevent variations in the result of determination of the entrance and exit.

While the foregoing example sets a plurality of thresholds for determining the boundary of the entrance RSSI area 108, a plurality of thresholds may be set for determining the boundary of the exit RSSI area 107 or a plurality of thresholds may be set for determining the boundary of the BLE communication area 6. In any case, the same effects as those achieved by each of the above-described embodiments can be achieved.

The wireless LAN communication scheme according to the fourth embodiment allows the received signal strength of the BLE communication to be regarded as the exit RSSI area 107 and the entrance RSSI area 108 to be set to any desired received signal strength level. As a result, the range in which connection to the wireless LAN can be made (the range of the entrance RSSI area 108) can be dynamically adjusted within the range of the BLE communication area 6. In addition, the same effects as those achieved by each of the above-described embodiments can be achieved.

### Fifth Embodiment

The following describes a wireless LAN communication scheme according to a fifth embodiment. The wireless LAN communication scheme according to each of the above-described embodiments uses the communication range information to detect presence of a device in the BLE communication area 6, and more specifically, uses the received signal strength indication (RSSI) of the BLE communication unit 17 to monitor the presence of a device in the BLE communication area 6. In contrast, the wireless LAN communication scheme according to the fifth embodiment prevents an inconvenience in which the connection processing and disconnection processing are repeatedly performed even when the determination of whether the smartphone 2 is located within the BLE communication area 6 changes. The following describes these different features and omits similarities found in each of the above-described embodiments.

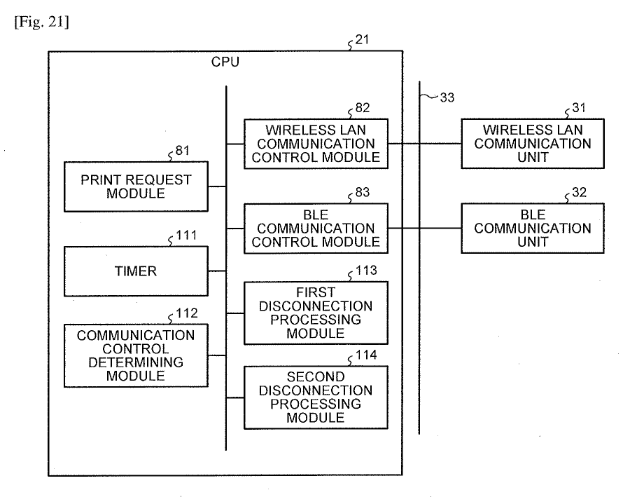

FIG. 21 is a functional block diagram of a smartphone that constitutes the wireless LAN communication scheme according to the fifth embodiment of the present invention. The smartphone 2 includes a timer 111, a communication range determining module 112, a first disconnection processing module 113, and a second disconnection processing module 114. Each of these modules represents a function or a means that is achieved by a corresponding element of the smartphone 2 illustrated in FIG. 3 operating in accordance with an instruction issued by the CPU 21 according to the communication control program stored in the ROM 22.

The communication range determining module 112 is achieved by an instruction from the CPU 21 illustrated in FIG. 3. By comparing the communication range information transmitted from the BLE communication unit 17 with information obtained by converting the received signal strength of the communication range information to a corresponding distance, the communication range determining module 112 determines whether a current position is located within the BLE communication area 6. The communication range determining module 112 then generates a response signal to which information indicating whether the current position is located within the BLE communication area 6 is appended and transmits the response signal from the BLE communication unit 32 to the BLE communication unit 17.

The second disconnection processing module 114 is achieved by an instruction from the CPU 21 illustrated in FIG. 3. The second disconnection processing module 114 disconnects the BLE communication with the BLE communication unit 17.

The timer 111 is achieved by an instruction from the CPU 21 illustrated in FIG. 3. The timer 111 measures an elapsed time since the BLE communication unit 32 no longer receives the communication range information transmitted from the BLE communication unit 17.

The first disconnection processing module 113 is achieved by an instruction from the CPU 21 illustrated in FIG. 3. The first disconnection processing module 113 disconnects the wireless LAN communication with the wireless LAN AP unit 16. The second disconnection processing module 114 resets and restarts the timer when the communication range information transmitted from the BLE communication unit 17 is received by the BLE communication unit 32. If a period of time during which the BLE communication unit 32 is unable to receive the communication range information continues and a predetermined period of time thereby elapses, the second disconnection processing module 114 determines that the timer has timed out and disconnects the communication with the wireless LAN AP unit 16. The first disconnection processing module 113 and the second disconnection processing module 114 are an exemplary disconnecting unit.

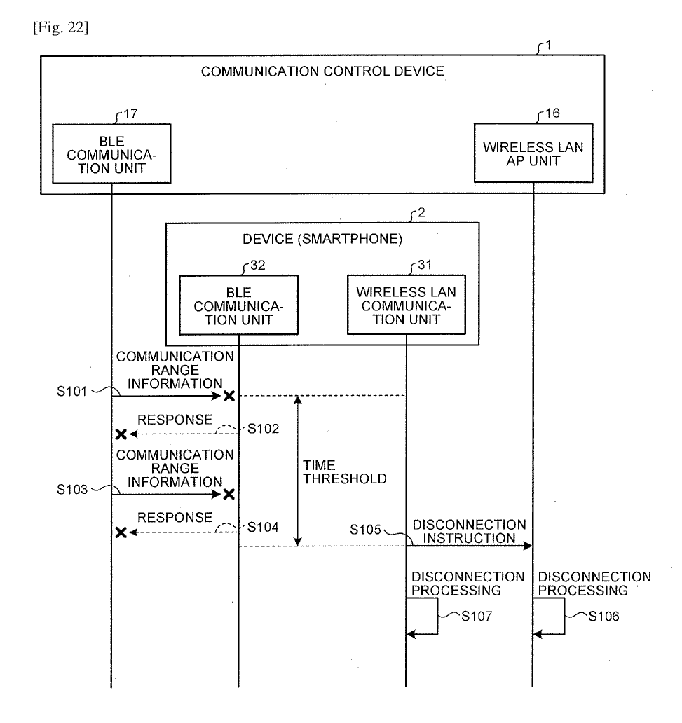

FIG. 22 is a flowchart illustrating disconnecting processing for the wireless LAN communication scheme according to the fifth embodiment of the present invention. In FIG. 22, the BLE communication area 6 approximates to an area formed by a range over which radio waves transmitted by the BLE communication unit 17 reach. As a result, the smartphone 2, as it moves from a position near the center of the BLE communication area 6 toward a circumference, receives the communication range information 112 at a position near a boundary of the range over which radio waves transmitted by the BLE communication unit 17 reach.

The smartphone 2, when moving from a position near the center of the BLE communication area 6 toward a circumference, for example, in a condition in which Steps S1 and S2 illustrated in FIG. 9 are performed at predetermined timing, becomes unable to receive the communication range information transmitted from the BLE communication unit 17.

At Step S101, although the BLE communication unit 17 transmits the communication range information, the smartphone 2 does not receive that communication range information.

At Step S102, the smartphone 2 is unable to transmit a response to the communication range information because the smartphone 2 was unable to receive the communication range information transmitted from the BLE communication unit 17. Because the second disconnection processing module 114 is unable to receive the communication range information at the predetermined timing, the timer 111 continues counting.

At Step S103, although the BLE communication unit 17 transmits the communication range information, the smartphone 6 does not receive that communication range information.

At Step S104, the smartphone 2 is unable to transmit a response to the communication range information because the smartphone 2 was unable to receive the communication range information transmitted from the BLE communication unit 17. The second disconnection processing module 114 keeps a started state of the timer 111 that has previously been started.

At Step S105, the second disconnection processing module 114 of the smartphone 2 detects that the timer 111 has been started and a preset first threshold time has elapsed. The second disconnection processing module 114 notifies the first disconnection processing module 113 that the time measured by the timer 111 has elapsed to exceed the first threshold time. The first disconnection processing module 113 transmits a disconnection instruction from the wireless LAN communication unit 31 to the wireless LAN AP unit 16.

At Step S106, the wireless LAN AP unit 16 performs internal disconnection processing therefor in accordance with the disconnection instruction transmitted by the wireless LAN communication.

At Step S107, the first disconnection processing module 113 of the smartphone 2 performs internal disconnection processing for the wireless LAN communication unit 31.

In the sequence chart illustrated in FIG. 22, Step S107 may be performed without Step S105. Because the wireless LAN communication is being carried out between the smartphone 2 and the wireless LAN AP unit 16, the performance of Step S107, which results in the smartphone 2 performing the disconnection processing for the wireless LAN communication, causes the disconnection processing to be performed also at the wireless LAN AP unit 16.

In this embodiment, the smartphone 2 performs processing to disconnect the communication with the wireless LAN AP unit 16, if it is unable to receive the communication range information transmitted from the BLE communication unit 17 even after the lapse of the first threshold time. This arrangement eliminates a condition in which connection to the wireless LAN AP unit 16 is left established as a result of the disconnection instruction not being received from the BLE communication unit 17, so that enhanced security can be achieved.

Additionally, the BLE communication area 6 is brought closer to the area formed by the range over which the radio waves transmitted by the BLE communication unit 17 reach. This arrangement can prevent an inconvenience in which the disconnection processing and the connection processing are repeatedly performed due to changes in the determination made as to whether the smartphone 2 is located within the BLE communication area 6.

### First Modification of Fifth Embodiment

In a wireless LAN communication scheme according to this modification, when, in the fifth embodiment, the smartphone 2 that performs communication with the wireless LAN AP unit 16 does not receive the communication range information even after the lapse of the above-described first threshold time after the reception of the communication range information has been disabled, and when a preset second threshold time elapses after transmission and reception of data with respect to the wireless LAN AP unit 16 has been halted, the smartphone 2 disconnects communication with the wireless LAN AP unit 16. It is noted that the data to be transmitted and received to and from the wireless LAN AP unit 16 is not for establishing a wireless link, but represents data on an application level, such as sound, video, and a transfer file.

When the above-described first threshold time elapses after the reception of the communication range information has been disabled in a condition in which data is being transmitted and received between the smartphone 2 and the wireless LAN AP unit 16, the communication between the smartphone 2 and the wireless LAN AP unit 16 is disconnected as described above. It is, however, not preferable that the communication between the smartphone 2 and the wireless LAN AP unit 16 be disconnected in a condition in which transmission and reception of data is yet to be completed between the smartphone 2 and the wireless LAN AP unit 16.

Thus, the wireless LAN communication scheme according to this modification is arranged as follows. Specifically, when the reception of the communication range information is disabled as described above, the second disconnection processing module 114 detects the halt of transmission and reception of data between the smartphone 2 and the wireless LAN AP unit 16 and resets the timer 111. When the elapsed time after the halt of transmission and reception of data then exceeds the preset second threshold time, the second disconnection processing module 114 disconnects the communication between the smartphone 2 and the wireless LAN AP unit 16.

The foregoing arrangement allows the communication between the smartphone 2 and the wireless LAN AP unit 16 to be maintained until the transmission and reception of data is completed, even when the reception of the communication range information is disabled as described above. This can prevent an unnecessary attempt to establish the network including performance of new connection processing in order to transmit and receive data that are yet to be transmitted and received, thereby enhancing security.

### Second Modification of Fifth Embodiment

In a wireless LAN communication scheme according to this modification, when, in the fifth embodiment, the smartphone 2 that performs communication with the wireless LAN AP unit 16 does not receive the communication range information even after the lapse of the preset first threshold time after the reception of the communication range information, and when a preset third threshold time elapses after the smartphone 2 has no longer been used, the smartphone 2 disconnects the communication with the wireless LAN AP unit 16. The smartphone 2 is determined to have no longer been used when, for example, a displacement amount of acceleration measured by an acceleration sensor included in the smartphone 2 is equal to or less than a predetermined displacement amount threshold.

Assume, for example, that the smartphone 2 that has been in use is disconnected as a result of the lapse of the preset first threshold time after the reception of the communication range information. In this case, to use the smartphone 2, the connection processing is newly performed between the smartphone 2 and the wireless LAN AP unit 16. In this modification, however, the communication with the wireless LAN AP unit 16 is disconnected when the elapsed continuous time during which the smartphone 2 is not in use exceeds the prescribed third threshold time. This eliminates the need for performing new connection processing. This precludes establishment of an unnecessary network to thereby enhance security.

### Third Modification of Fifth Embodiment

In a wireless LAN communication scheme according to this modification, when, in the fifth embodiment, the smartphone 2 that performs communication with the wireless LAN AP unit 16 does not receive the communication range information even after the lapse of the preset first threshold time after the reception of the communication range information, and when a prescribed fourth threshold time elapses after the use of an application installed in the smartphone 2 has been discontinued, the smartphone 2 disconnects the communication with the wireless LAN AP unit 16.

Assume, for example, that the smartphone 2 in which the previously installed application has been in use is disconnected as a result of the lapse of the preset first threshold time after the reception of the communication range information. In this case, to use the application installed in the smartphone 2, the connection processing is newly performed between the smartphone 2 and the wireless LAN AP unit 16. In this modification, however, the communication with the wireless LAN AP unit 16 is disconnected when the preset fourth threshold time elapses after the application installed in the smartphone 2 has no longer been used. This eliminates the need for performing new connection processing. This precludes establishment of an unnecessary network to thereby enhance security.

### Fourth Modification of Fifth Embodiment

In a wireless LAN communication scheme according to this modification, when, in the fifth embodiment, the smartphone 2 that performs communication with the wireless LAN AP unit 16 does not receive the communication range information even after the lapse of the preset first threshold time after the reception of the communication range information, and when the user operates to disconnect the smartphone 2, the communication with the wireless LAN AP unit 16 is disconnected. Specifically, the communication with the wireless LAN AP unit 16 is disconnected when the user of the smartphone 2 intentionally operates for disconnection. This arrangement allows the user of the smartphone 2 to have authority to establish a network, so that unnecessary disconnection processing can be prevented.

### Fifth Modification of Fifth Embodiment

In a wireless LAN communication scheme according to this modification, the threshold time is set to a longer time than a transmission cycle of the communication range information transmitted by the BLE communication unit 17 in the first embodiment. Exemplarily, the BLE communication unit 17 often transmits the communication range information at intervals of 100 ms. The smartphone 2 determines whether it is located within the BLE communication area 6 by receiving the communication range information. Thus, the smartphone 2 makes the determination according to the transmission cycle of the communication range information.

After the connection processing has been performed between the smartphone 2 and the wireless LAN AP unit 16, however, the processing to determine exit from the BLE communication area 6 is estimated to be less affected even if it is performed at a cycle longer than the transmission cycle of the communication range information.

Specifically, the threshold time to make the determination as to whether the smartphone 2 exits from the BLE communication area 6 may be set in advance to one second to about five seconds. This determination to be made in units of seconds enables a determination of an actual exit even for a user who frequently enters and exits from the BLE communication area 6. With the threshold time set to a short time, if inability to receive the communication range information occurs frequently as a result of the user's entering and exiting from the BLE communication area 6 frequently, the determination as to whether the user exits from the BLE communication area 6 alternates frequently. Setting a longer threshold time allows the location within the BLE communication area 6 to be made on a basis of a user's moving speed. This enhances accuracy to determine whether the smartphone 2 is located in the BLE communication area 6.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

### REFERENCE SIGNS LIST

1 Communication range limiting device
2 Smartphone
3 Printer device
4 Projector device
5 Wireless LAN communication area
6 BLE communication area
6′ BLE communication area
7 Wireless LAN communication-disabled area
15 Input/output I/F
16 Wireless LAN AP unit
17 BLE communication unit
31 Wireless LAN communication unit
32 BLE communication unit
47 Wireless LAN communication unit
48 BLE communication unit
75 Device connecting module
76 Peripheral device connecting module
77 Withdrawal detecting module
78 Wireless LAN AP control module
79 BLE communication control module
81 Print request module
82 Wireless LAN communication control module
83 BLE communication control module
85 Print module
86 Wireless LAN communication control module
87 BLE communication control module
91 First communication establishing device
92 Second communication establishing device
101 Speaker unit
102 Microphone unit
103 Microphone unit
104 Microphone/speaker unit
107 Exit RSSI area
108 Entrance RSSI area
111 Timer
112 Communication range determining module
113 First disconnection processing module
114 Second disconnection processing module

### CITATION LIST

### Patent Literature

PTL 1: Japanese Laid-open Patent Publication No. 2002-351766

1. A communication device comprising:
a communication unit that performs communication with another communication device in a first range through a first communication scheme; and
a detecting unit that detects prescribed information within a second range different from the first range, wherein
when the detecting unit detects the prescribed information, the communication unit performs communication with the other communication device within the second range through the first communication scheme.

2. The communication device according to claim 1, further comprising:
an establishing unit that uses the prescribed information to establish communication through the first communication scheme with the other communication device; and
a disconnecting unit that disconnects the communication through the first communication scheme established with the other communication device when the other communication device moves out of the second range.

3. The communication device according to claim 2, wherein the disconnecting unit disconnects the communication through the first communication scheme established with the other communication device when the detecting unit is unable to detect the prescribed information.

4. The communication device according to claim 1, wherein
the prescribed information is unique identification information or a public key for the first communication, and
the communication unit performs the first communication with the other communication device using the unique identification information or the public key detected by the detecting unit.

5. The communication device according to claim 1, wherein the detecting unit detects the prescribed information using communication through a second communication scheme that enables communication in the second range different from the first range.

6. The communication device according to claim 5, wherein the communication through the second communication scheme is Bluetooth (registered trademark) Low Energy (BLE) communication.

7. The communication device according to claim 5, wherein the communication through the second communication scheme is Near Field Communication (NFC).

8. The communication device according to claim 5, wherein the communication through the second communication scheme is optical communication.

9. The communication device according to claim 5, wherein the detecting unit detects the prescribed information when received signal strength of the communication through the second communication scheme is equal to or greater than a first threshold.

10. The communication device according to claim 5, wherein the disconnecting unit disconnects the communication through the first communication scheme established with the other communication device when the received signal strength of the communication through the second communication scheme in the detecting unit is equal to or lower than a second threshold.

11. The communication device according to claim 1, wherein the detecting unit detects the prescribed information with sound having a prescribed frequency.

12. (canceled)

13. The communication device according to claim 2, wherein the detecting unit, when having moved into the second range again after disconnection of the communication through the first communication scheme established with the other communication device, detects information different from the prescribed information used before the disconnection.

14. The communication device according to claim 2, further comprising:
a timer that measures an elapsed time after the detecting unit has no longer detected the prescribed information, wherein
the disconnecting unit disconnects the communication through the first communication scheme established with the other communication device when the elapsed time exceeds a prescribed first threshold time.

15. The communication device according to claim 14, wherein the disconnecting unit disconnects the communication between the communication unit and the other communication device when the elapsed time after the prescribed information has no longer been detected exceeds the first threshold time and a prescribed second threshold time elapses after transmission and reception of data between the communication unit and the other communication device has been halted.

16. The communication device according to claim 14, wherein the disconnecting unit disconnects the communication between the communication unit and the other communication device when the elapsed time after the prescribed information has no longer been detected exceeds the first threshold time and a continuous elapsed time during which the communication device is not in use exceeds a prescribed third threshold time.

17. The communication device according to claim 14, wherein the disconnecting unit disconnects the communication between the communication unit and the other communication device when the elapsed time after the prescribed information has no longer been detected exceeds the first threshold time and a prescribed fourth threshold time elapses after use of an application that is usable in the communication device has been discontinued.

18. The communication device according to claim 14, wherein the disconnecting unit disconnects the communication between the communication unit and the other communication device when the elapsed time after the prescribed information has no longer been detected exceeds the first threshold time and when a disconnection operation with respect to the communication device is detected.

19. The communication device according to claim 2, wherein, after the communication through the first communication scheme has been established by the establishing unit, the detecting unit detects the prescribed information at intervals longer than those before establishment of the communication through the first communication scheme.

20. A communication method comprising:
detecting, by a detecting unit, prescribed information within a second range different from a first range; and
performing communication, by a communication unit, with another communication device within the second range through a first communication scheme when the prescribed information is detected at the detecting.

21. (canceled)

22. A computer program product comprising a non-transitory computer-readable medium containing an information processing program, the program causing a computer to function as:
a detecting unit that detects prescribed information within a second range different from a first range; and
a communication unit that performs communication with another communication device within the second range through a first communication scheme when the prescribed information is detected.
